(19) United States
(12) Patent Application Publication
(10) Pub. No.: US 2010/0004955 A1
(43) Pub. Date: Jan. 7, 2010

(54) BUSINESS HSA PLATFORM

(75) Inventors: Bruce Telkamp, Los Altos, CA (US); Samuel C. Gibbs, III, Portola, CA (US)

Correspondence Address: SCHWEGMAN, LUNDBERG & WOESSNER, P.A., P.O. BOX 2938, MINNEAPOLIS, MN, 55402, US

(73) Assignee: eHealth, Inc., Mountain View, CA (US)

(21) Appl. No.: 12/167,603

(22) Filed: Jul. 3, 2008

(51) Int. Cl. G06Q 40/00

(52) U.S. Cl. 705/4; 705/35; 705/1

(57) ABSTRACT

A business HSA platform is provided. The system may include an eligibility detector, an HSA setup module, an HSA expenditures manager, and an employer contributions manager. The eligibility detector may be configured to determine health savings account (HSA) eligibility of an employee. The HSA setup module may be configured to establish an HSA account for the employee. The HSA expenditures manager may be configured to facilitate on-line management of the HSA account. The employer contributions manager may be configured to facilitate automatic contributions by an employer of the employee into the HSA account.

### TECHNICAL FIELD

This disclosure relates generally to the technical fields of software and/or hardware technology and, in one example embodiment, to a platform for enrollment and management of health insurance plans in conjunction with health saving accounts (HSAs).

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Employer costs for group health insurance have gone up 87% from 2000 to 2006, resulting in the percentage of employers offering coverage dropping from 69% to 59% and employees, and employee portions of premium payments going from $135 to $226 from 2000 to 2005. In addition, employees are actually declining insurance at an increasing rate where it is offered by employers (19.7% declined in 2003 vs. 14.7% in 1998), likely due to these cost increases. Also, the percentage of small firms offering health benefits decreased from 58% in 2001 to 45% in 2007. With these data points in mind, many employers are struggling to find solutions that help their employees obtain health insurance without double-digit inflation increases every year.

One approach taken by some employers is to no longer offer an Employer-sponsored health insurance plan. Some employers are instead willing to contribute to the employees' health-care spending via a Health Savings Account (HSA). An HSA is a personal bank account into which an individual can contribute his pre-tax dollars to pay for health insurance costs. HSAs are transportable, they belong to the individual, not the employer, and so if the individual leaves his job, he takes his HSA with him. To be eligible to open and maintain an HSA, an employee may be required to have a High Deductible Health Plan (HDHP) as their only form of health insurance coverage.

### BRIEF DESCRIPTION OF DRAWINGS

Embodiments are illustrated by way of example and not limitation in the figures of the accompanying drawings, in which like references indicate similar elements and in which:

FIG. 1 is a block diagram showing a network environment within which a platform to manage health saving accounts (HSAs) may be implemented, in accordance with an example embodiment;

FIG. 2 is a block diagram illustrating an HSA management system, in accordance with an example embodiment;

FIG. 3 is a flow chart illustrating a method for establishing and managing an HSA, in accordance with an example embodiment;

FIG. 4 is a flow chart illustrating an employer enrollment process, in accordance with an example embodiment;

FIG. 5 is a flow chart illustrating an employee enrollment process, in accordance with an example embodiment;

FIG. 6 is a diagrammatic representations of a user interface (UI) presented by an HSA management system to collect from employer information regarding contribution levels for eligible employees, in accordance with an example embodiment;

FIG. 7 is a diagrammatic representations of a UI presented by an HSA management system to collect from employer information for generating a company profile, in accordance with an example embodiment; and

FIG. 8 is a diagrammatic representation of a machine in the example form of a computer system within which a set of instructions, for causing the machine to perform any one or more of the methodologies discussed herein, may be executed.

### DETAILED DESCRIPTION

Employers desiring to contribute to an employee's HSA account in lieu of sponsoring employee health insurance face a host of logistical challenges. Because HSAs are an individual asset, employers have a difficult time integrating employer benefit plans, payroll and other processes with the individual nature of HSAs. For example, because the employer is not providing health insurance coverage, then the employer does not have a mechanism for confirming that its employees have purchased their own HDHP plan or when to stop contributions because an employee has cancelled that plan. In fact, the employer may have to navigate a myriad of Federal laws that govern employee benefits, health insurance, privacy, and HSAs. The employer may face the task of how to contribute to an employee's HSA without violating any of those laws. The inventors realized that for the HSA to be a true benefit to both the employer and the employee, the process for enrolling, maintaining and contributing to an HSA account must be easy to understand and use so that employees choose to participate in the HSA option.

A business HSA platform, in one example embodiment, may be utilized by employers in assisting employees with obtaining health insurance and managing healthcare costs. The business HSA platform may be configured to facilitate creating a business HSA program by an employer. An employer may open a business HSA account with the business HSA platform provider (e.g., with eHealthInsurance Services, Inc.) and offer a business HSA benefit to employees. In offering such benefit, an employer may set desired contribution levels for employees.

In one embodiment, a business HSA platform may be configured to provide an online portal accessible by employers (an employer portal) and an online portal accessible by employees (an employee portal). An employer with a business HSA account may use the employer portal, e.g., to add or remove employees that are eligible for the business HSA benefit, to set and adjust HSA contribution levels for different groups of employees, and to make automatic contributions to employees' HSA accounts. It will be noted that, for the purposes of this description, the terms HSA and HSA account may be used interchangeably.

An employee portal may be provided by a business HSA platform to facilitate obtaining of an HSA-eligible health insurance policy by an employee, as well as to permit an employee to open an HSA account online. For example, employees may be provided with an online resource to shop for HSA-eligible insurance plans, establish their own HSA accounts, and then track HSA contributions and expenses. Employees may also be permitted to select an option where the business HSA platform may automatically attend to premium payments for employee's health insurance policy.

As will be described in greater detail further below, a business HSA platform may be configured to cooperate with computer systems of other organizations. For example, a business HSA platform may include a bank integration module to permit communications and exchange of data with computer systems of various financial institutions (e.g., banks). A bank integration module may be utilized, for example, to permit an employee to establish an HSA account. A business HSA platform may also include an insurance integration module to permit an on-line process of obtaining a health insurance policy. In order to permit automatic payment of insurance premiums by employees, a business HSA platform may be configured with an integration module to permit communications and exchange of data with a payroll computer system. Example business HSA platform may be implemented as an HSA management system in the context of a network environment.

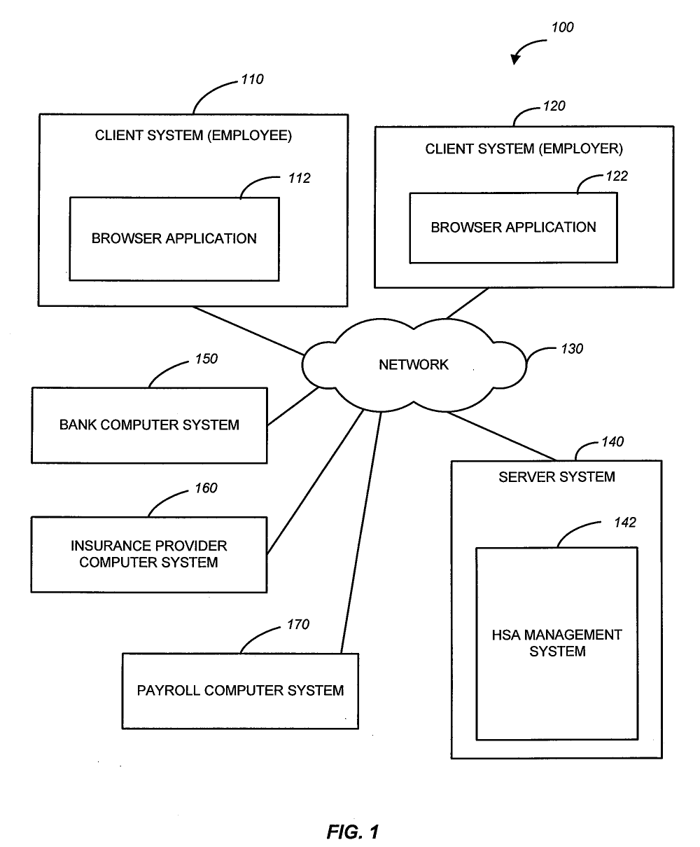

FIG. 1 shows an example network environment 100, within which an example HSA management system may be implemented. The network environment 100 may include one or more client systems, such as a client system 110 and a client system 120, and a server system 140 hosting and HSA management system 142. The client systems 110, 120, and the server system 140 may be in communication with each other via a network 130. The communications network 130 may be a public network (e.g., the Internet, a wireless network, a public switched telephone network (PSTN), etc.) or a private network (e.g., LAN, WAN, Intranet, etc.).

The HSA management system 142 may be configured to provide access to various services to users via online portals. As mentioned above, in one embodiment, the HSA management system 142 may be configured to provide a so-called employer portal and a so-called employee portal. As shown in FIG. 1, the client system 110 (designated as being controlled by an employee) includes a browser application 112 that can be used by an employee to access services provided by the HSA management system 142 via an employee portal. The client system 120 is designated in FIG. 1 as being controlled by an employer. The client system 120 may host a browser application 122 which, in turn, may be used by an employer to access services provided by the HSA management system 142 via the employer portal.

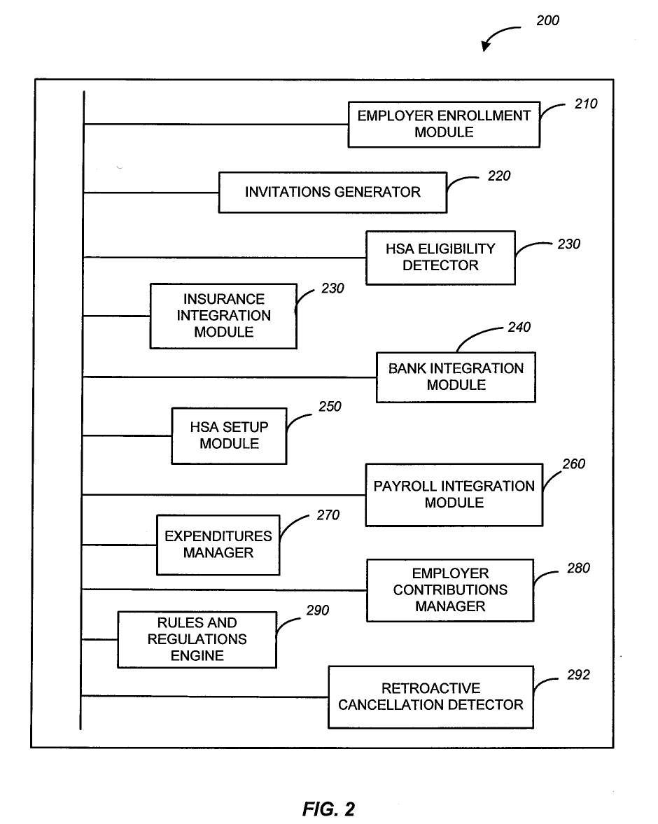

Also shown in FIG. 1 are a bank computer system 150, an insurance provider computer system 160 and a payroll computer system 170. In some embodiments, the HSA management system 142 may be configured to include integration modules to permit communications and exchanges of data with these computer systems 150, 160 and 170. For example, as mentioned above, the HSA management system 142 may include an integration module to permit automatic payment of premiums for insurance policy on behalf of an employee, payroll deductions for employees to make their own contributions to their HSA bank account, all directly through the payroll computer system 170. One embodiment of the HSA management system 142 may be described in greater detail with reference to FIG. 2.

FIG. 2 is a block diagram illustrating an HSA management system 200, in accordance with an example embodiment. The system 200 may include a variety of modules. Some of the modules may be configured to accommodate employer enrollment into a business HSA program, while other modules may be configured to facilitate employee enrollment in the HSA benefit. Yet another group of modules in the system 200 may be configured to facilitate management of an HSA account by an employee such as viewing any HSA-eligible expenditures, requesting and viewing HSA-related reports, effectuating payments for health related expenses from the HSA account, etc. The system 200 may also include modules configured to facilitate automatic employer contributions into employees' HSA accounts.

As shown in FIG. 2, the system 200 includes an employer enrollment module 210. The employer enrollment module 210, in one embodiment, is configured to facilitate setting up of a business HSA program for an employer. The process of setting up a business HSA program for an employer, otherwise referred to as employer enrollment process, may include presenting an employer with an online survey to determine whether a business HSA program is the right approach for the particular employer, as well as providing an employer with a comparison between a business HSA program and a group health insurance. Also, an employer enrollment process may include collecting various information associated with the employer and her employees (e.g., details such as contribution levels that employer would be willing to contribute into employees' HSA accounts) and providing to an employer a user agreement letter for employer's signature. The process of employer enrollment into a business HSA program, if successful, concludes with establishing a business HSA account for the employer.

Also shown in FIG. 2, is an invitations generator 220. When the employer enrollment module 210 determines that an employer has successfully established a business HSA account, the employer is presented with an employer portal mentioned above and requested to enter email addresses of any employees that may be subject to the business HSA benefit. The invitations generator 220 obtains employee email addressed and generates email messages inviting employees to enroll into the HSA benefit. An example email, that may be referred to as an HSA invitation email, generated by the invitations generator 220 may, for example, read as follows:
“Dear Employee,
We know how important affordable health care is to you and your family and we want to do our part to help you tackle the high cost of health care today that is why we are inviting you to participate in our new business HSA program. Here it how it works:
If you purchase an HSA eligible health insurance plan and open a health saving account, we will contribute funds to your account which you may use to pay for qualifying medical expenses on a tax-free basis or save for retirement. We will contribute $57.53 per paycheck up to $1,500 a year for all qualified employees. If you have at least one eligible dependent, we will provide $95.89 per paycheck up to $2,500 per year.”

An HSA invitation email may also include a link to an the employee enrollment homepage that may be used by an employee to use services provided by the HSA management system 200 that would permit an employee to either set up an HSA account and, if necessary, first obtain a high deductible health insurance policy. If an employee activates the link and enters the employee enrollment homepage, the HSA management system 200 engages its modules configured to facilitate the process of employee enrollment. As shown in FIG. 2, the system 200 includes an HSA eligibility detector 230, an insurance integration module 232, a bank integration module 240, and an HSA setup module 250. The HSA eligibility detector 230 may be configured to determine whether an employee is eligible for the HSA benefit being offered by an employer. In order to make such determination, the HSA eligibility detector 230 may be configured to cooperate with a rules and regulations engine 290, also part of the system 200. The rules and regulations engine 290, in turn, may be configured to access a rules database (not shown) that may store information regarding the rules and policies governing health savings accounts as well as any applicable tax rules.

If the HSA eligibility detector 230 determines that an employee is not eligible for the HSA benefit, e.g., because the employee does not have a high-deductable health insurance policy, the system 200 may present the employee with instructions regarding obtaining such high deductable health insurance policy, otherwise referred to as an HSA eligible health insurance policy. If the employee indicates that she wishes to high deductable health insurance policy, the system 200 may engage an insurance integration module 232 in order to facilitate an online process of obtaining of an HSA eligible health insurance policy by an employer. For example, the insurance integration module 232 may permit an employee to select an insurance plan and apply for such health insurance coverage online. If the HSA eligibility detector 230 determines that the employee is eligible to setup an HSA account, the system 200 may engage an HSA setup module 250. The HSA setup module 250 may be configured to cooperate with a bank integration module 240 to facilitate the setting up of an HSA account for the employee.

The modules configured to facilitate the management of an employee's HSA account include a payroll integration module 260, an expenditures manager 270, and an employer contributions manager 280. The payroll integration module 260 may be configured to effectuate automatic payments of health insurance premiums on behalf of an employee, as well as by an employee (e.g., the employer's contribution to the HSA as well as the employee's contribution to her account). Thus, while a health insurance policy may be owned by the employee (as opposed to owned by the employer as in group health insurance plans) and is managed by the employee herself, the system 200 permits automatic health insurance premium payment on behalf of the employee utilizing the payroll integration module 260. The expenditures manager 270, in one embodiment, may be configured to permit an employee to manage her HSA expenditures online via the employee portal. The expenditures manager 270 may be configured to generate a summary of HSA eligible expenditures, to generate and print reports, as well as to create customized expense categories related to HSA eligible expenses. The expenditures manager 270 may also be configured to provide information such as a list of eligible expenses or other HSA related information.

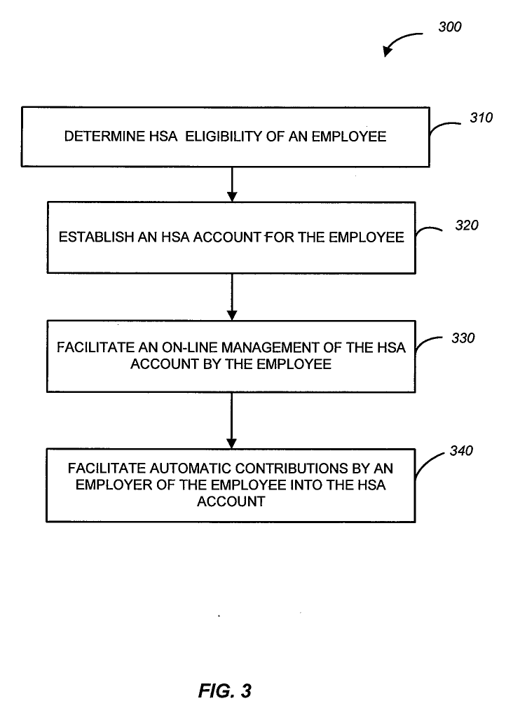

Also shown in FIG. 2, is an employer contributions manager 280. The employer contributions manager 280 may be utilized to facilitate employer access to services provided by the system 200 via an online employer portal. The employer contributions manager 280 may be configured to monitor total employer contributions year to date, total contributions scheduled through the end of the year, total open accounts related to employees, total balance of all accounts, an average balance per account, an average employer deposit, as well as other information. The employer contributions manager 280 may also be configured to generate reports relating to recent activity with respect to the employer HSA account such as the dates of employer contributions, the status of those contributions whether they are pending, completed or scheduled, as well as generating reports. Various operations performed by the HSA management system 200, according to an example embodiment, may be discussed with reference to FIG. 3.

FIG. 3 is a flow chart illustrating a method 300 for establishing and managing an HSA, in accordance with an example embodiment. The method 300 may be performed by processing logic that may comprise hardware (e.g., dedicated logic, programmable logic, microcode, etc.), software (such as run on a general purpose computer system or a dedicated machine), or a combination of both. The processing logic, according to example embodiments, may reside in any of the modules shown in FIG. 2.

The method 300 commences at operation 310 where the HSA eligibility detector 230 of FIG. 2 determines HSA eligibility of an employee. At operation 320, the HSA setup module 250 of FIG. 2 establishes an HSA account for the employee. At operation 330, the expenditures manager 270 of FIG. 2 facilitates an online management of the HSA account by the employee. The expenditures manager 270 may cooperate with other modules provided with the HSA management system 200 of FIG. 2, in order to facilitate management of the HSA account by the employee.

The employer contributions manager 280 of FIG. 2 is invoked at operation 340 to facilitate automatic contributions by the employee's employer into the HSA account. The HSA management system 200 of FIG. 2, thus, may be utilized to provide and facilitate a streamlined HSA process that informs employees and employers about a business HSA benefit, guides employer in establishing such benefit for employees, invites employees into participating in the benefit, and guides them in becoming eligible for setting up an HSA account. The HSA management system 200 may also be utilized beneficially to facilitate management of the established HSA account by the employee and to facilitate management of employer contributions into the HSA account.

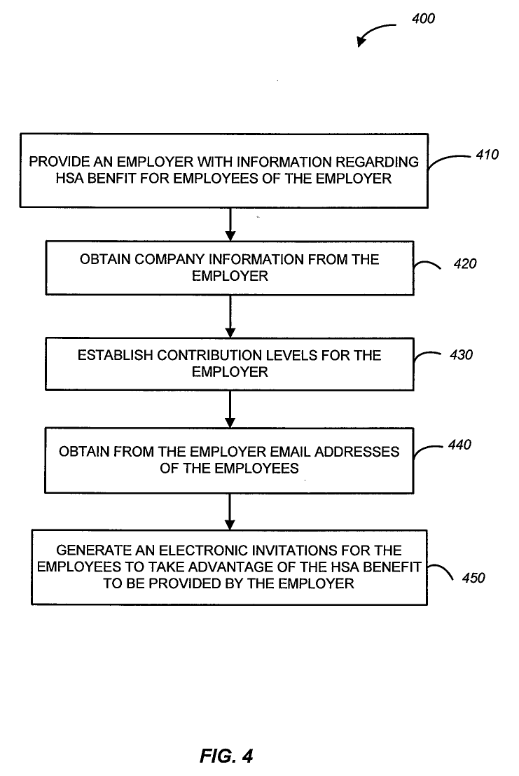

In facilitating employer contributions management, the system 200 of FIG. 2 may be configured to detect a possibility of a retroactive cancellation of employee health insurance policy and alert the employer. For example, the system 200 may include a retroactive cancellation detector 292 to detect potential retroactive cancellation and to provide an alert to the employer. For example, the retroactive cancellation detector 292 may detect a failure to pay the insurance premium and, in response, suppress the next employer contribution into the employee's HSA account. As mentioned above, the system 200 may trigger employer's enrollment into a business HSA program. Example operations performed in the process of employer enrollment into the business HSA program may be discussed with reference to FIG. 4.

FIG. 4 is a flow chart illustrating an employer enrollment process, a method 400, in accordance with an example embodiment. The method 400 may be performed by processing logic that may comprise hardware (e.g., dedicated logic, programmable logic, microcode, etc.), software (such as run on a general purpose computer system or a dedicated machine), or a combination of both. The processing logic, according to example embodiments, may reside in any of the modules shown in FIG. 2.

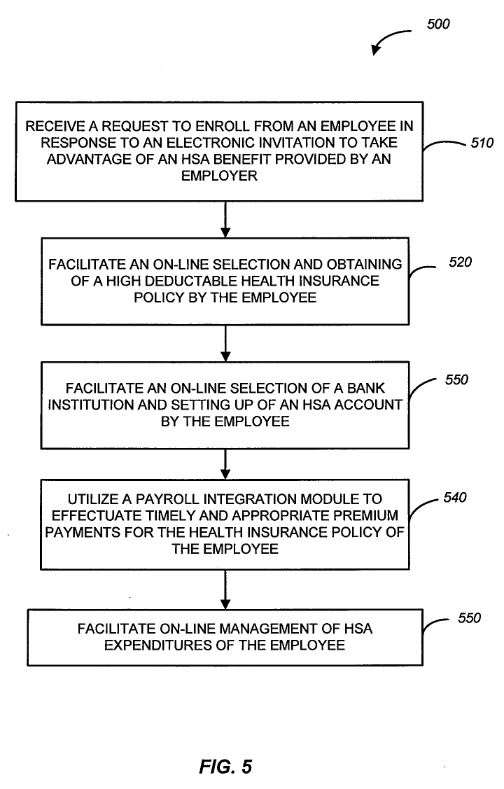

The method 400 commences with operation 410 where the employer enrollment module 210 of FIG. 2 provides an employer with information regarding a business HSA program that would allow the employer to offer an HSA benefit for the employer's employees. At operation 420, the employer enrollment module 210 obtains company information from the employer and establishes contribution levels for the employer at operation 430. At operation 440, the invitations generator 220 of FIG. 2 obtains, from the employer, email addresses of those employees that may be subject to the HSA benefit. At operation 450, the invitations generator 220 of FIG. 2 generates electronic invitations for the employees inviting the employees to take advantage of the HSA benefit. As mentioned above, the email generated by the invitations generator 220 of FIG. 2 may include, in one embodiment, a link that can be activated by the employee in order to obtain more information about the HSA benefit and in order to enrol into the HSA benefit. Some operations performed in the process of employee enrollment may be discussed with reference to FIG. 5.

FIG. 5 is a flow chart illustrating an employee enrollment process, in accordance with an example embodiment. The method 400 may be performed by processing logic that may comprise hardware (e.g., dedicated logic, programmable logic, microcode, etc.), software (such as run on a general purpose computer system or a dedicated machine), or a combination of both. The processing logic, according to example embodiments, may reside in any of the modules shown in FIG. 2.

The method 500 commences with operation 510 where the HSA management system 200 of FIG. 2 receives a request from an employee to enrol into an HSA benefit in response to receiving an electronic invitation. At operation 520, the system 200 facilitates an online selection of a high deductible health insurance policy by the employee. When the HSA eligibility detector 230 of FIG. 2 determines that the employee is eligible for an HSA benefit, the system 200 engages the bank integration module 240 of FIG. 2 to facilitate an online selection of a bank institution and the setting up of an HSA account for the employee. At operation 540, the system 200 of FIG. 2 utilizes the payroll integration module 260 to effectuate timely premium payments for the health insurance policy of the employee. At operation 550, the system 200 engages the expenditures manager 270 to facilitate online management of HSA expenditures by the employee.

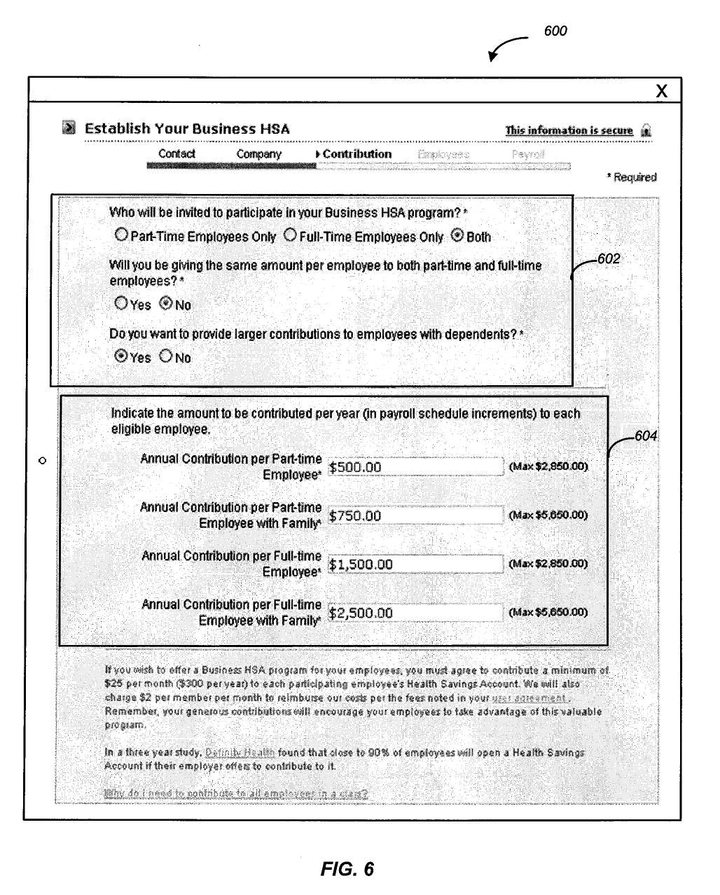

FIG. 6 is a diagrammatic representations of a user interface (UI) 600 presented by an HSA management system to collect from employer information regarding contribution levels for eligible employees, in accordance with an example embodiment. The user interface 600 includes an area 602 that may be used to collect information regarding the employees that would be invited to participate in the employer's business HSA program. For example, in the area 602, the employer may indicate that the business HSA program is available to part-time employees only, to full time employees only, or to both part-time and full time employees. The area 602 may also permit the employer to indicate whether the same amount per employee would be contributed into respective HSA accounts for both part-time and full time employees and also whether the employer intends to provide larger contributions to employees with dependents. In area 604 of the user interface 600, as shown in FIG. 6, the employer is permitted to indicate the amount to be contributed per year to respective HSA accounts of the employees. For example, as shown in area 604, the annual contribution for a part-time employee is $500, the annual contribution for a part-time employee with family is $750, and the annual contribution for a full time employee is $1,500 and, finally, the annual contribution for a full time employee with family is $2,500.

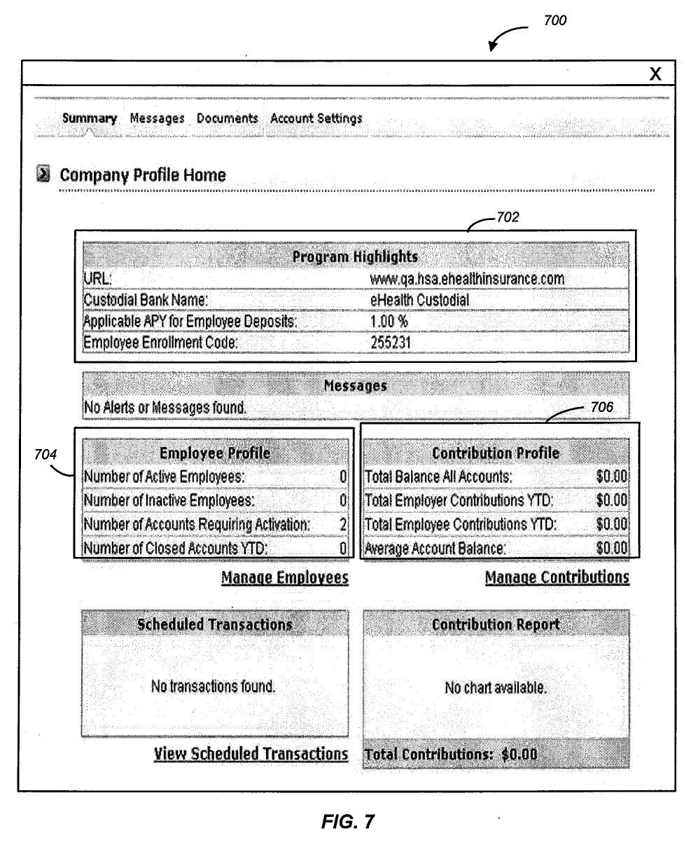

FIG. 7 shows a diagrammatic representation of a user interface (UI) 700 presented by the HSA management system 200 to collect, from employer, information for generating a company profile, in accordance with an example embodiment. The user interface 700 includes an area 702 that provides a link to the HSA system 200 provider's homepage, the name of a custodial bank, the percentage of applicable API for employee deposits as well as employee enrollment code. In an area 704, the user interface 700 includes information regarding a so-called “employee profile” for the company, such as the number of active employees, the number of inactive employees, the number of accounts requiring activation, as well as the number of closed accounts year to date. In an area 706 of the user interface 700, the employer may view a so-called “contributions profile” that includes information such as total balance for all accounts, total employer contributions year to date, total employee contributions year to date, as well as average account balance. It will be noted, that FIG. 6 and FIG. 7 provide just some of example views generated by the system 200 of FIG. 2 to be presented to and accessible by employers.

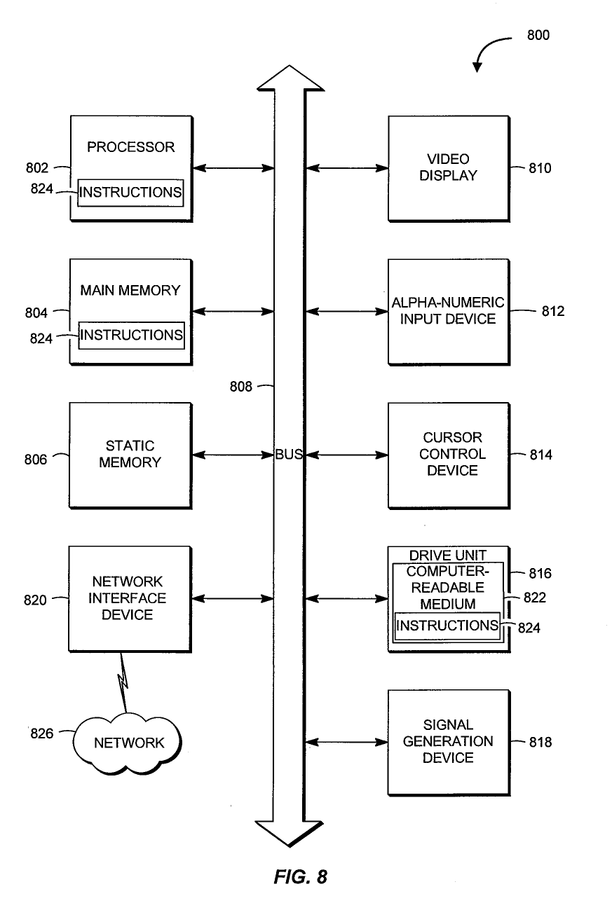

FIG. 8 is a diagrammatic representation of a machine in the example electronic form of a computer system 800 within which a set of instructions, for causing the machine to perform any one or more of the methodologies discussed herein, may be executed. In various embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an “Moving Picture Experts Group (MPEG) Layer 3” (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation device 814 (e.g., a mouse), a disk drive unit 816, a signal generation device 818 (e.g., a speaker) and a network interface device 820.

The disk drive unit 816 includes a computer-readable (or machine-readable) medium 822 on which is stored one or more sets of instructions and data structures (e.g., software 824) embodying or utilized by any one or more of the methodologies or functions described herein. The software 824 may also reside, completely or at least partially, within the main memory 804 and/or within the processor 802 during execution thereof by the computer system 800, the main memory 804 and the processor 802 also constituting machine-readable media.

The software 824 may further be transmitted or received over a network 826 via the network interface device 820 utilizing any one of a number of well-known transfer protocols (e.g., Hyper Text Transfer Protocol (HTTP)).

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Such medium may also include, without limitation, hard disks, floppy disks, flash memory cards, digital video disks, random access memory (RAMs), read only memory (ROMs), and the like.

Thus, an example HSA management system has been described. The embodiments described herein may be implemented in an operating environment comprising software installed on a computer, in hardware, or in a combination of software and hardware. Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. A system comprising:
an eligibility detector to determine health savings account (HSA) eligibility of an employee;
an HSA setup module to establish an HSA account for the employee;
an HSA expenditures manager to facilitate on-line management of the HSA account; and
an employer contributions manager to facilitate automatic contributions by an employer of the employee into the HSA account.

2. The system of claim 1, wherein the HSA setup module is to establish an HSA account utilizing a bank integration module to access a bank computer system electronically.

3. The system of claim 1, comprising an insurance integration module to facilitate on-line process for the employee to obtain a health insurance policy.

4. The system of claim 3, comprising a payroll integration module to facilitate automatic premium payments for the health insurance policy and employee HSA contributions.

5. The system of claim 3, comprising a retroactive cancellation detector to detect a failure to pay a premium the health insurance policy and to suppress automatic contributions by the employer into the HSA account.

6. The system of claim 1, wherein the employer contributions manager is to determine a permissible contribution level for the HSA account of the employee.

7. The system of claim 1, comprising an employer enrollment module to provide the employer with information regarding an HSA benefit and to obtain from the employer email addresses of employees.

8. The system of claim 7, comprising an invitations generator to utilize email addresses of the employees to invite the employees to take advantage of the HSA benefit.

9. A computer-implemented method comprising:
utilizing a health insurance account (HSA) setup module and a bank integration module to facilitate an on-line process for establishing an HSA account for an employee;
facilitating on-line management of the HSA account by the employee; and
facilitating automatic contributions by an employer of the employee into the HSA account.

10. The method of claim 9, comprising determining HSA eligibility of the employee prior to the establishing of the HSA for the employee.

11. The method of claim 10, comprising facilitating an on-line process for obtaining a health insurance policy for the employer prior to the establishing of the HSA for the employee.

12. The method of claim 11, comprising utilizing a payroll integration module to effectuate automatic premium payments for the health insurance policy and employee HSA contributions.

13. The method of claim 11, wherein the facilitating of automatic contributions by the employer comprises monitoring permissible HSA contribution levels.

14. The method of claim 9, comprising:
detecting a failure to pay a premium for an HSA eligible health insurance policy of the employee; and
providing an indication of the failure to the employer.

15. The method of claim 14, comprising suppressing automatic contributions by the employer.

16. A computer-implemented method comprising:
receiving a request from an employer to enroll in a business HSA program, the business HSA program to provide HSA benefit to the employer's employees;
facilitating an on-line process for enrolling the employer into the business HSA program,
obtaining, from the employer, email addresses of the employer's employees;
automatically generating and distributing email messages to the employees, the email messages to invite the employees to enroll in the HSA benefit;
detecting a request from an employee from the employer's employees; and
responding to the request from the employee by facilitating an on-line process for enrolling the employee in the HSA benefit.

17. The method of claim 16, including facilitating on-line management of the HSA account by the employee.

18. The method of claim 16, including facilitating automatic contributions by the employer into the HSA account.

19. The method of claim 18, wherein the facilitating of automatic contributions by the employer comprises utilizing a retroactive cancellation detector to determine that premium payments for an HSA-eligible health insurance policy of the employer are up to date.

20. A machine-readable medium may be provided having instruction data to cause a machine to:
determine health savings account (HSA) eligibility of an employee;
establish an HSA account for the employee;
facilitate on-line management of the HSA account;
facilitate automatic contributions by an employer of the employee into the HSA account.
